(19) United States
(12) Patent Application Publication
(10) Pub. No.: US 2024/0338238 A1
(43) Pub. Date: Oct. 10, 2024

(54) HOST TO GUEST NOTIFICATION

(71) Applicant: Intel Corporation, Santa Clara, CA (US)

(72) Inventors: Wei Wang, Shanghai (CN); Kun Tian, Shanghai (CN); Guang Zeng, Shanghai (CN); Gilbert Neiger, Portland, OR (US); Rajesh Sankaran, Portland, OR (US); Asit Mallick, Saratoga, CA (US); Jr-Shian Tsai, Portland, OR (US); Jacob Jun Pan, Portland, OR (US); Mesut Ergin, Portland, OR (US)

(73) Assignee: Intel Corporation, Santa Clara, CA (US)

(21) Appl. No.: 18/574,849

(22) PCT Filed: Jan. 26, 2022
(86) PCT No.: PCT/CN2022/073993

§ 371 Date: Dec. 28, 2023

(51) Int. Cl. G06F 9/455; G06F 9/30

(52) U.S. Cl. CPC G06F 9/45558; G06F 9/3016; G06F 9/45545; G06F 2009/45579

(57) ABSTRACT

A method and system of host to guest (H2G) notification are disclosed. H2G is provided via an instruction. The instruction is a send user inter-processor interrupt instruction. An exemplary processor includes decoder circuitry to decode a single instruction and execute the decoded single instruction according to the at least the opcode to cause a host to guest notification from a virtual device running in a host machine on the first physical processor to a virtual device driver running on a virtual processor in a guest machine on a second physical processor.

### BACKGROUND

Virtualized datacenters are used extensively to provide digital services including web hosting, streaming services, remote computing, and more. Virtualized datacenters are highly scalable. Virtualization allows the creation of multiple simulated environments, operating systems (OS), or dedicated resources from a single, physical hardware system. Virtualization is implemented using software, such as a virtual machine manager (VMM), which is also sometimes referred to as a hypervisor, to manage software known as a “guest” or virtual machine (VM). A virtual machine is software that, when executed on appropriate hardware, creates an environment allowing for the abstraction of an actual physical computer system also referred to as a “host” or “host machine.” In other words, a virtual machine is software that simulates a physical computer system. There may be multiple virtual machines running on a single host machine. Like physical computer systems, each virtual machine may run its own guest operating system (OS) and applications, as well as interact with peripheral devices such as Peripheral Component Interconnect express (PCIe) devices.

Host to guest (H2G) notification is a common and frequent operation in a virtualization environment. A virtual device (e.g., virtio-net device) is usually emulated on the host environment and a virtual device driver (e.g., virtio-net driver) runs in the guest machine. The virtual device often needs to notify the virtual device driver to process requests (e.g., receiving network packets).

### BRIEF DESCRIPTION OF DRAWINGS

Various embodiments in accordance with the present disclosure will be described with reference to the drawings:

FIG. 1 illustrates a computing system including an embodiment for inter-processor interrupts.

FIG. 2 is a flow diagram of host to guest notification processing according to an embodiment.

FIG. 3 illustrates an arrangement for host to guest processing in a computing system in an embodiment.

FIG. 4 illustrates a processor for host to guest notification according to an embodiment.

FIG. 5 illustrates a posted interrupt descriptor (PID) and a user posted interrupt descriptor (UPID) according to an embodiment.

FIG. 6 illustrates embodiments of an exemplary computing system.

FIG. 7 illustrates a block diagram of embodiments of a processor that may have more than one core, may have an integrated memory controller, and may have integrated graphics.

FIG. 8(A) is a block diagram illustrating both an exemplary in-order pipeline and an exemplary register renaming, out-of-order issue/execution pipeline according to embodiments of the invention.

FIG. 8(B) is a block diagram illustrating both an exemplary embodiment of an in-order architecture core and an exemplary register renaming, out-of-order issue/execution architecture core to be included in a processor according to embodiments of the invention.

FIG. 9 illustrates embodiments of execution unit(s) circuitry, such as execution unit(s) circuitry of FIG. 8(B).

FIG. 10 is a block diagram of a register architecture according to some embodiments.

FIG. 11 illustrates embodiments of an instruction format.

FIG. 12 illustrates embodiments of an addressing field.

FIG. 13 illustrates embodiments of a first prefix.

FIGS. 14(A)-(D) illustrate embodiments of how the R, X, and B fields of the first prefix are used.

FIGS. 15(A)-(B) illustrate embodiments of a second prefix.

FIG. 16 illustrates embodiments of a third prefix.

FIG. 17 illustrates a block diagram contrasting the use of a software instruction converter to convert binary instructions in a source instruction set to binary instructions in a target instruction set according to embodiments of the invention.

### DETAILED DESCRIPTION

The present disclosure relates to methods, apparatus, systems, and non-transitory computer-readable storage media for host to guest notification in a virtualization environment.

Most current virtual devices are emulated in host user space, for example by a user space QEMU (an open-source hypervisor) thread. It is also an emerging trend to move the kernel part of backend acceleration (which is usually treated as part of the device emulation) into user space (e.g., a vhost-user backend in data plane development kit (DPDK) for a virtual network device backend and storage plane development kit (SPDK) for virtual storage device backend).

In general, the existing host to guest notification path from a virtual device running on a first physical processor to a virtual device driver running on a second physical processor requires multiple levels of software. Some QEMU virtual devices in a legacy mode of operation deliver interrupts to the target virtual processor's local advanced programmable interrupt controller (APIC) through a software emulated virtual input/output (I/O) APIC, but most current virtual peripheral component interface (PCI) devices supported in QEMU use message signaled interrupt (MSI) or message signaled interrupt-x (MSIx) based interrupts, which bypass IOAPIC emulation. Even in the MSI/MSIx case, a QEMU virtual device needs to make an “ioctl” call to send an MSI message to a kernel-based virtual machine (KVM) to perform MSI emulation. KVM parses the MSI message, iterates through a list of the guest machine's virtual processors to find a match with the target virtual processor, and notifies the target virtual processor by configuring the posted interrupt descriptor (PID) of the virtual processor and sending an inter-processor interrupt (IPI) using the posted interrupt (PI) notification vector to the physical processor that runs the target virtual processor. This legacy process takes approximately 1,600 cycles in tests.

In an embodiment, the technology described herein provides a hardware-assisted host to guest (H2G) notification by extending the existing Send User Inter-processor Interrupts (SENDUIPI) instruction set architecture (ISA). The SENDUIPI based IPI delivery of embodiments described herein takes only approximately 260 cycles.

The SENDUIPI instruction was originally proposed in the user interrupt (UI) architecture for sending interrupt notifications between user space threads on the same host. The extension proposed herein provides for sending interrupt notifications between the host and the guest.

In an embodiment, the SENDUPI instruction, as documented in the Intel Architecture Instruction Set Extensions and Future Features Programming Reference, March 2020, and later versions, takes a single 64-bit register operand. Although SENDUIPI may be executed at any privilege level, all the instruction's memory accesses are performed with supervisor privilege. In an embodiment, when a selected register operand is an index into a user interrupt target table (UITT) and the PID type field of the indexed table entry indicates the address in the entry points to a memory location in user posted interrupt descriptor (UPID) format (i.e., the PID type field is 0), the processor sends a user inter-processor interrupt using a UPID to a selected processor, and when the selected register operand is an index into the UITT and the PID type field of the indexed table entry indicates the address in the entry points to a memory location of the target virtual processor's (e.g., guest machine's) posted interrupt descriptor (PID) memory in PID format (i.e., the PID type field is 1), the processor sends a PID to a selected processor.

The SENDUIPI architecture is extended with the support to send a posted interrupt from host user space to a target virtual processor. A virtual device in host user space executes the SENDUIPI instruction, and the host processor's microcode (ucode) gets a corresponding user interrupt target table (UITT) entry (indexed by an instruction operand of the SEDUIPI instruction), configures the target processor's PID pointed by the entry, and then sends a posted interrupt (PI) IPI to the physical processor that runs the target virtual processor (e.g., guest machine). The technology described herein allows virtualization software to run with better performance on processors implementing an embodiment. For example, the device emulation (e.g., virtual network cards, virtual block devices) will be more efficient, because the frequent host virtual device to guest driver notification is improved with lower overhead.

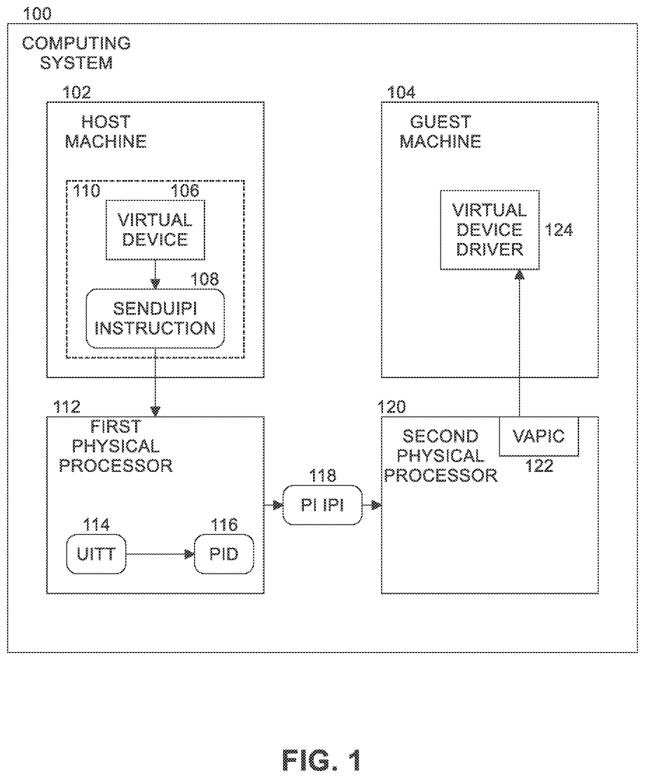

FIG. 1 illustrates computing system 100, including an embodiment of the present invention for inter-processor interrupts. Computing system 100 may represent any type of information processing system, such as a server, a disaggregated server, a desktop computer, a portable computer, a set-top box, a hand-held device such as a tablet or a smart phone, or an embedded control system.

Systems embodying the present invention may include any number of each of these components and any other components or other elements, such as peripherals and/or I/O devices. Any or all the components or other elements in this or any system embodiment may be connected, coupled, or otherwise in communication with each other through any number of buses, point-to-point, or other wired or wireless interfaces or connections, unless specified otherwise. Any components or other portions of computing system 100, whether shown in FIG. 1 or not shown in FIG. 1, may be integrated or otherwise included on or in a single chip (a system-on-a-chip or SOC), die, substrate, or package.

Note that the name of the SENDUIPI instruction referred to herein is provided merely for convenience, and embodiments of the present invention may include any such comparable instruction having any desired name. In various embodiments, one or more variants of the SENDUIPI instruction may be added to an existing ISA as an enhancement, extension, or other variant of one or more existing instructions or opcodes. Also note that a processor's execution of and/or response to an SENDUIPI instruction may also or instead be performed (and/or possibly referred to below as an SENDUIPI operation or function) in response to or in connection with other events (e.g., a write to or setting of bits of a command, model-specific, or other register).

Computing system 100 include at least one host machine 102 and at least one guest machine 104. Host machine 102 runs on first physical processor 112, and guest machine 104 runs on second physical processor 120. Virtual device 106 runs in user space 110 on host machine 102. Virtual device driver 124 runs on guest machine 104. From time to time, virtual device 106 notifies virtual device driver 124 of an event occurring in computing system 100. In legacy approaches, implementation of this host to guest (H2G) notification requires computing system 100 to traverse multiple levels of software components (some shown in FIG. 1 and some not shown in FIG. 1) for virtual device 106 to notify virtual device driver 124, thereby incurring additional overhead and a negative impact on overall performance of computing system 100.

In an embodiment, when virtual device 106 needs to notify virtual device driver 124, virtual device 106 executes an instruction, called a SENDUIPI instruction herein, to send the notification from first physical processor 112 to second physical processor 120, and onward to virtual device driver 124. In particular, since host machine 102 is executed by first physical processor 112, the SENDUIPI instruction is executed by the first physical processor. As part of the implementation of the SENDUIPI instruction, the first physical processor gets an entry in a user interrupt table (UITT) 114 indexed by an operand of the instruction. The first physical processor configures a PID 116 associated with the entry in the UITT. The first physical processor 112 sends a posted interrupt (PI) inter-processor posted interrupt (IPI) 118 to the second physical processor 120. In response to receiving the PI IPI 118, the second physical processor notifies the virtual device driver 124 using virtual advanced programmable interrupt controller (VAPIC) 122. In an embodiment. VAPIC 122 virtualized with the assistance from the processor hardware.

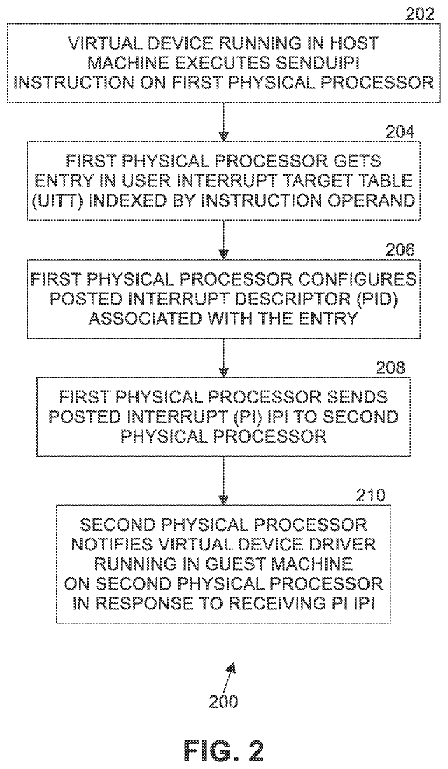

FIG. 2 is a flow diagram of host to guest notification processing 200 according to an embodiment. At block 202, virtual device 106 running in host machine 102 executes a SENDUIPI instruction on first physical processor 112. At block 204, first physical processor 112 gets an entry from a user interrupt target table (UITT) 114 indexed by an operand of the SENDUIPI instruction. At block 206, first physical processor configures a posted interrupt descriptor (PID) 116 associated with the UITT entry. At block 208, the first physical processor sends a posted interrupt (PI) inter-processor posted interrupt (IPI) 118 to second physical processor 120 running virtual device driver 124 in guest machine 104. At block 210, second physical processor 120 notifies virtual device driver 124 running in guest machine 104 on the second physical processor in response to receiving the PI IPI 118.

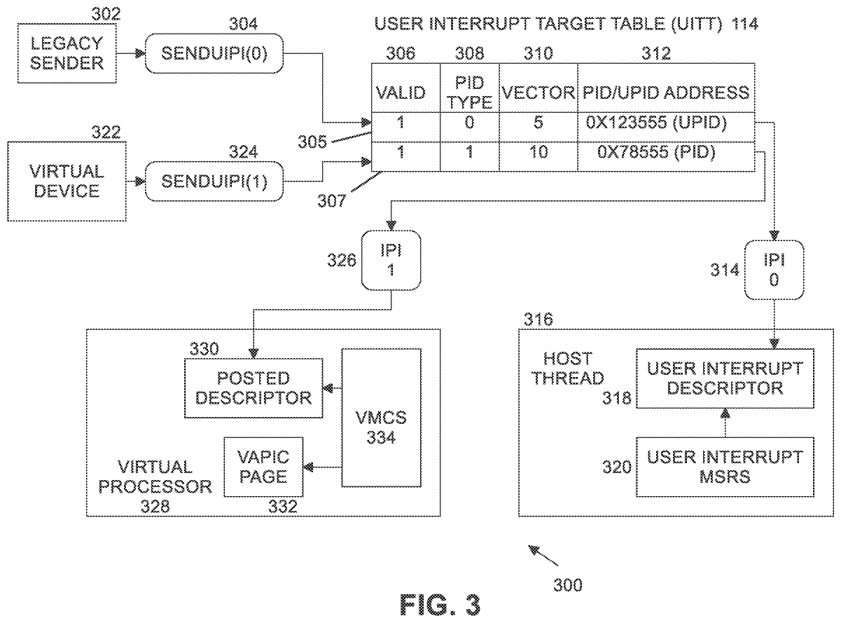

FIG. 3 illustrates an arrangement for host to guest 104 processing in a computing system 100 in an embodiment. A virtual processor utilizes a virtual machine control structure (VMCS) 334 during virtual machine execution. The VMCS 334 is used in the management of transitions into and out of a virtual machine execution non-root operation (sometimes called VM entry and VM exit). A VMM can use a different VMCS for each virtual machine that it supports. For a virtual machine with multiple logical processors (virtual processors), the VMM can use a different VMCS for each virtual processor.

A virtual (logical) processor associates a region in memory with each VMCS. This region is called the VMCS region. Software references a specific VMCS using the physical address of the region (a VMCS pointer). A logical processor may maintain a number of VMCSs that are active. The processor may optimize VM operation by maintaining the state of an active VMCS in memory, on the processor, or both. At any given time, at most one of the active VMCSs is the current VMCS.

As shown, a least the first physical processor 112 includes an UITT 114. This structure includes a plurality of fields per entry. In some embodiments, these fields include one or more of a validity field 306, a PID type field 308, a vector field 310, and a PID/UPID address field 312. For example, the validity field 306 indicates if the entry is valid or not. The PID type field 308 specifies if the receiver processor (virtual or physical) is using a posted interrupt descriptor (PID) (or other host posted interrupt format) or a user posted interrupt description (UPID) format. The PID/UPID address field 312 stores an address of a PID or UPID such that a PID/UPID to be used to post an interrupt to a target VM may be found. The vector field 310 stores a virtual interrupt vector corresponding to the particular notification and/or interrupt to be sent to the target VM.

A “PID type” field 308 is added to the UITT 114 entry to indicate if the UITT entry points to UPID or PID memory in first physical processor 112. When PID type field 308 is 0, the UITT entry refers to an address of a UPID in field 312, and when the PID type field 308 is 1, the UITT entry refers to an address of a PID in field 312. In the example shown in FIG. 3, there are two senders on the host machine 102. Legacy sender 302 is a host user space thread that needs to send a notification to another user space thread (e.g., host thread 316) on the same host machine 102. In this scenario, legacy sender 302 executes a SENDUIPI (0) instruction 304. Corresponding UITT entry 0 305 is allocated and set up by a SENDUIPI host kernel driver (not shown in FIG. 1) in advance. The UITT entry 305 for the SENDUIPI (0) instruction 304 points to the address of the UPID of the target thread (e.g., a host thread 316) in PID/UPID address field 312. First physical processor 112 sends IPI 0 314 to the host thread 316 (running on a second physical processor) where the IPI 314 is handled by host thread 316 using user interrupt descriptor 318 and user interrupt MSRs 320.

The virtual device 322 is another host user space thread (e.g., a QEMU device emulation thread for virtual device 106) and the virtual device 322 needs to send a notification to software (e.g., the notification target) on guest machine 104 running on a different physical processor 120. In this scenario, virtual device 322 executes a SENDUIPI (1) instruction 324. Corresponding UITT entry 1 307 has been allocated for the virtual device sender at the virtual device setup stage. The UITT entry 307 for the SENDUIPI (1) instruction 324 points to the address of the PID 116 of the target virtual processor in field 312. When the virtual device executes the SENDUIPI instruction with “entry number=1” passed as the instruction operand, the ucode of the first physical processor indexes (with the “1”) into UITT 114, gets the corresponding UITT entry 307, and performs the following operations: 1) Check that the “valid” bit of entry 307 is 1; 2) Set “vector” field 310 of entry 307 to PID.PIR field 503 (e.g., the 10^{th} bit); and 3) Send IPI 1 326 (by writing to the ICR register) with PID.NV as the notification vector to the physical processor, whose APIC ID equals to PID.NDST. Then a (target) third physical processor identifies and delivers the interrupt to the virtual processor 328 running virtual device driver 124 in the guest machine 104 (using posted descriptor 330, VASPIC page 332, and VMCS 334 as is well known) by executing the posted interrupt processing steps, including operating on the PID (e.g., clearing the outstanding-notification bit) and virtual APIC page (e.g., setting a bit in the vIRR field), as documented in the Intel® software development manual.

In an embodiment, software running on the host machine and the guest machine may be set up as follows. At initialization of virtual device driver 124 on the guest machine 104, a guest kernel allocates an interrupt vector for the virtual device driver. The virtual device driver writes the vector to a virtual device register emulated by QEMU. The QEMU virtual device receives the “vector” number from the virtual device driver 124. Then QEMU finds the MSI message (e.g., MSI address and data) from a virtual device PCI configuration space emulated by QEMU (e.g., the MSI capability or the MSIX table from the PCI base address register (BAR) memory-mapped I/O (MMIO) region). The MSI message is sent to a kernel-based virtual machine (KVM) in host kernel space via an “ioctl” command to perform notification setup. The above steps are the legacy behavior, which remains the same in embodiments.

If hardware-assisted H2G notification is enabled, a new flag is passed with the above “ioctl” command to the KVM to perform the SENDUIPI based H2G notification setup as follows. KVM gets the target virtual processor's PID (the target virtual processor's APIC ID is indicated via the MSI address) and guest vector (obtained from the MSI data), and makes a function call to the SENDUIPI driver to: 1) allocate a UITT entry; 2) set the guest vector to UITT.vector; 3) set the physical address of the PID to UITT.PID; and 4) set UITT.valid to 1. The allocated UITT entry number (assume it is “1”) is returned to the QEMU virtual device 106.

When the virtual device 106 needs to send a H2G notification to the guest virtual device driver 124, the virtual device executes SENDUIPI with “entry=1” as the instruction operand, then the ucode of the first physical processor checks the UITT table entry 1 to send the notification to the target physical processor as described above.

Later, if the target virtual processor gets re-scheduled to a new physical processor, KVM (the hypervisor in the host kernel managing the PIDs of the virtual processors) gets notified from the kernel thread scheduler callback to update the virtual processor's PID.NDST field to the new physical processor's APIC ID. If the target virtual processor gets blocked, KVM will update its PID.NV to a special wakeup vector, and in this case execution of the SENDUIPI instruction will simply trigger the wakeup vector's handler on the host machine 102, which wakes up the target virtual processor thread first and the notification interrupt is then delivered after the virtual processor “VMEnters” the guest mode.

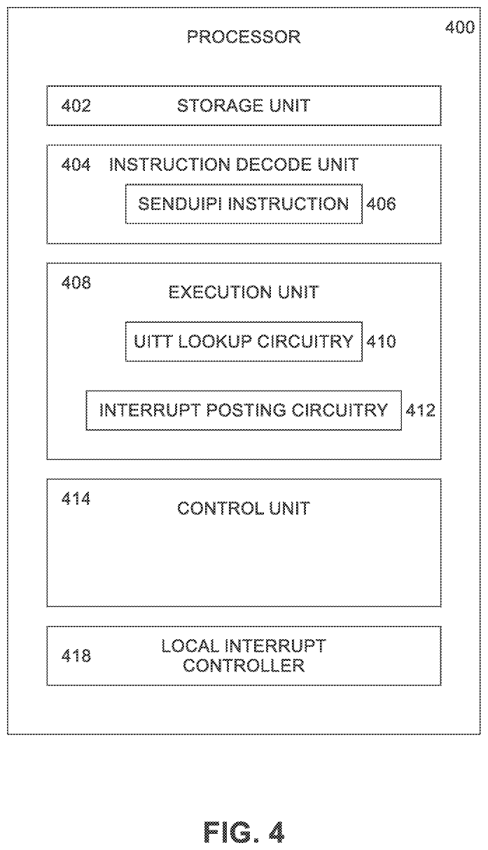

FIG. 4 illustrates processor 400, which may represent an embodiment of first physical processor 112 and/or second physical processor 120 in FIG. 1. Processor 400 may include storage unit 402, instruction decode unit 404, execution unit 408, control unit 414, and local interrupt controller 418. Processor 400 may also include any other circuitry, structures, or logic not shown in FIG. 4.

Storage unit 402 may include any combination of any type of storage usable for any purpose within processor 400; for example, it may include any number of readable, writable, and/or read-writable registers, buffers, and/or caches, implemented using any memory or storage technology, in which to store capability information, configuration information, control information, status information, performance information, instructions, data, and any other information usable in the operation of processor 400, as well as circuitry usable to access such storage and/or to cause or support various operations and/or configurations associated with access to such storage.

Instruction decode unit 404 may include any circuitry, logic, structures, and/or other hardware, such as an instruction decoder, to fetch, receive, decode, interpret, schedule, and/or handle instructions (including SENDUIPI instruction 406, described below) to be executed by processor 400. Any instruction format may be used within the scope of the present invention; for example, an instruction may include an opcode and one or more operands, where the opcode may be decoded into one or more micro-instructions or micro-operations for execution by execution unit 408. Operands or other parameters may be associated with an instruction implicitly, directly, indirectly, or according to any other approach.

Execution unit 408 may include any circuitry, logic, structures, and/or other hardware, such as arithmetic units, logic units, floating point units, shifters, etc., to process data and execute instructions, micro-instructions, and/or micro-operations. Execution unit 408 may represent any one or more physically or logically distinct execution units. Execution unit 408 may include UITT lookup circuitry 410 to use a handle from a SENDUIPI instruction to find a PID address and an interrupt vector in a UITT 114, as described below. Execution unit 408 may also include interrupt posting circuitry 412 to post an interrupt, as described below.

Control unit 414 may include any microcode, firmware, circuitry, logic, structures, and/or hardware to control the operation of the units and other elements of processor 400 and the transfer of data within, into, and out of processor 400. Control unit 414 may cause processor 400 to perform or participate in the performance of method embodiments of the present invention, such as the method embodiments described below, for example, by causing processor 400, using execution unit 408 and/or any other resources, to execute instructions received by instruction unit 404 and micro-instructions or micro-operations derived from instructions received by instruction unit 404. The execution of instructions by execution unit 408 may vary based on control and/or configuration information stored in storage unit 402.

Local interrupt controller 418 may include any circuitry, logic, structures, and/or other hardware to receive, generate, prioritize, deliver, hold pending, or otherwise control or manage interrupt requests. For example, local interrupt controller 418 may be a local APIC in a processor in the Core® Processor Family from Intel Corporation. Embodiments of the present invention may include virtualization of local interrupt controller 418, according to any known approach, to provide a virtual local interrupt controller for each virtual processor abstracted from processor 400.

Processor 400 may support virtualization according to any approach. For example, processor 400 may operate in two modes-a first (root) mode in which software runs directly on the hardware, outside of any virtualization environment, and a second (non-root) mode in which software runs at its intended privilege level, but within a virtual environment hosted by a VMM running in the first mode. In the virtual environment, certain events, operations, and situations, such as interrupts, exceptions, and attempts to access privileged registers or resources, may be intercepted, i.e., cause the processor to exit the virtual environment (a VM exit) so that the VMM may operate, for example, to implement virtualization policies. The processor may support instructions for establishing, entering (a VM entry), exiting, and maintaining a virtual environment, and may include register bits or other structures that indicate or control virtualization capabilities of the processor.

In describing embodiments of the present invention, any platform, system, or machine, including the “bare metal” platform shown as computing system 100 in FIG. 1 as well as any VM or other container abstracted from a bare metal platform, from which one or more VMs may be abstracted may be referred to as a host or host machine, and each VM abstracted from a host machine may be referred to as a guest or guest machine. Accordingly, the term “host software” may mean any hypervisor, VMM, OS, or any other software that may run, execute, or otherwise operate on a host machine and create, maintain, and/or otherwise manage one or more VMs, and the term “guest software” may mean any OS, system, application, user, or other software that may run, execute, or otherwise operate on a guest machine. Note that in a layered container architecture, software may be both host software and guest software. For example, a first VMM running on a bare metal platform may create a first VM, in which a second VMM may run and create a second VM abstracted from the first VM, in which the case the second VMM is both host software and guest software.

Processor 400 may control the operation of one or more VMs according to data stored in one or more VMCSs. A VMCS is a data structure that may contain state of one or more guests, state of a host, execution control information indicating how a VMM is to control operation of a guest or guests, execution control information indicating how VM exits and VM entries are to operate, information regarding VM exits and VM entries, and any other such information. Processor 400 may read information from a VMCS to determine the execution environment of a VM and constrain its behavior. Embodiments may use one VMCS per VM or any other arrangement. Each VMCS may be stored, in whole or in part, in a system memory, and/or elsewhere, such as being copied to a cache memory of a processor.

According to embodiments of the present invention, a VMCS (e.g., VMCS 334) may include a first pointer to a first data structure (e.g., virtual APIC (VAPIC) page 332) to be used in the virtualization of a local interrupt controller (e.g., local interrupt controller 418) and a second pointer (e.g., PID 116 pointer) to a second data structure (e.g., posted descriptor 330) to be used in the posting of interrupts to a virtual processor. Virtualization of a local interrupt controller and posting of interrupts to a virtual processor may each be implemented according to any known approach, such that the resources of each VM may include one or more virtual processors, each with a corresponding virtual local interrupt controller, such that interrupts may be sent to each VM (e.g., guest machine) abstracted from computing system 100.

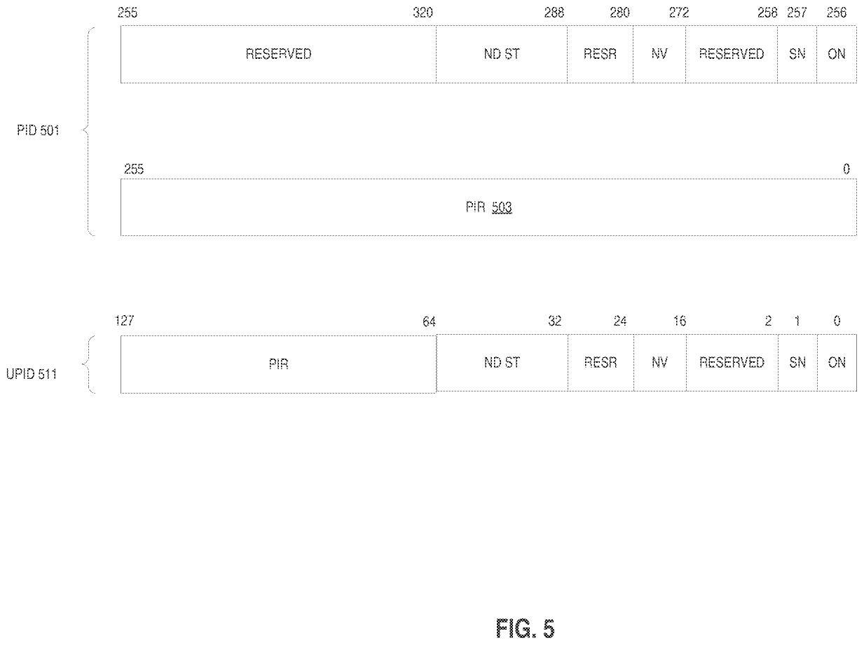

FIG. 5 illustrates embodiments of a PID and a UPID. Software, such as a virtual machine manager (VMM), may allocate a PID for each virtual processor that may be the target of a posted interrupt (PI) IPI. Generally, an agent “posts” the interrupt in a data structure (e.g., the posted-interrupt descriptor (PID) and then sends an interrupt (notification) to the logical processor on which the target virtual device driver is operating. When that logical processor receives the notification, it uses information in the PID to deliver the virtual interrupt to the virtual device driver.

Each PID may have a format as illustrated in FIG. 5. In this illustration. PID 501 is a 512-bit value. A 256-bit posted interrupt request (PIR) field 503 is used to identify interrupts. For example, in some embodiments, each bit of the PIR field 503 may correspond to one of 256 virtual interrupt vectors for the virtual processor corresponding to the PID. Each bit of the PIR field 503 may be set to post an interrupt request for a corresponding virtual interrupt vector (e.g., the virtual interrupt vector specified by vector field). One or more fields are used indicate attributes of a notify event to be used to inform a VMM of pending posted interrupts. In an embodiment, the event used to notify a VMM that posted interrupts are pending may be a physical interrupt request to a physical processor. Therefore, using a physical processor that may support over one hundred physical interrupts, embodiments of the present invention may provide for over one hundred virtual processors per physical processor.

Bits 319:256 provide notification information, organized as follows: bit 256 is an outstanding notification (ON) bit and when set there is a notification outstanding for one or more posted interrupts in PIR; bit 257 is a suppress notify (SN) bit and the setting of this bit directs agents not to send notifications; bits 279:272 are a notify vector (NV); and bits 319:288 delineate a notify destination (NDST) wherein notifications will be directed to this physical APIC ID.

The UPID 511 has a similar format but is more compressed in that it has a smaller PIR in some embodiments.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

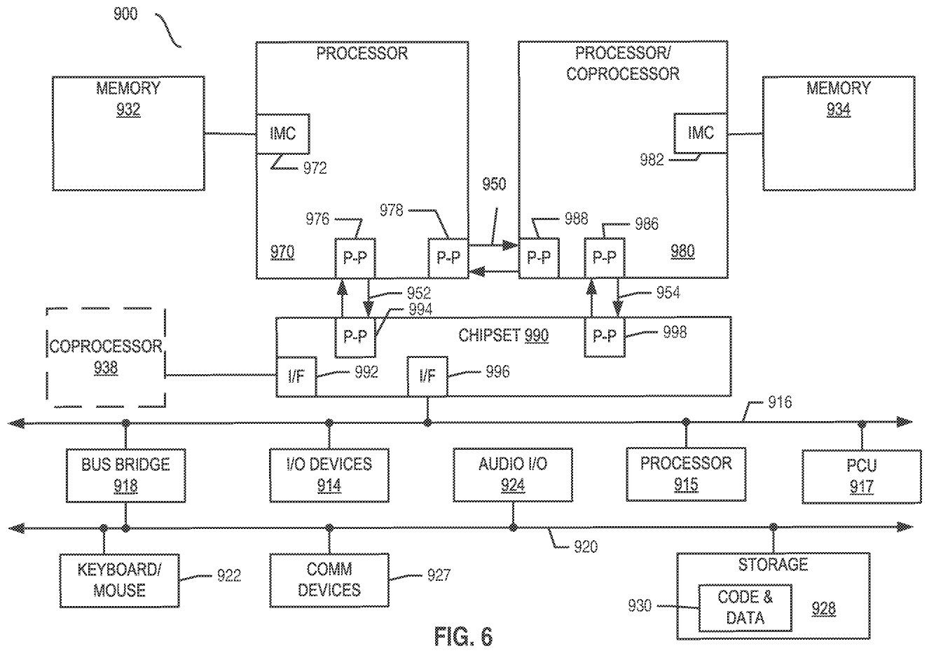

FIG. 6 illustrates embodiments of an exemplary system. Multiprocessor system 900 is a point-to-point interconnect system and includes a plurality of processors including a first processor 970 and a second processor 980 coupled via a point-to-point interconnect 950. In some embodiments, the first processor 970 and the second processor 980 are homogeneous. In some embodiments, first processor 970 and the second processor 980 are heterogenous.

Processors 970 and 980 are shown including integrated memory controller (IMC) units 972 and 982, respectively. Processor 970 also includes as part of its interconnect controller units point-to-point (P-P) interfaces 976 and 978; similarly, second processor 980 includes P-P interfaces 986 and 988. Processors 970, 980 may exchange information via the point-to-point (P-P) interconnect 950 using P-P interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a chipset 990 via individual P-P interconnects 952, 954 using point to point interface circuits 976, 994, 986, 998. Chipset 990 may optionally exchange information with a coprocessor 938 via a high-performance interface 992. In some embodiments, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor 970, 980 or outside of both processors, yet connected with the processors via P-P interconnect, such that either or both processors' local cache information may be stored in the shared cache if a processor is placed into a low power mode.

Chipset 990 may be coupled to a first interconnect 916 via an interface 996. In some embodiments, first interconnect 916 may be a Peripheral Component Interconnect (PCI) interconnect, or an interconnect such as a PCI Express interconnect or another I/O interconnect. In some embodiments, one of the interconnects couples to a power control unit (PCU) 917, which may include circuitry, software, and/or firmware to perform power management operations with regard to the processors 970, 980 and/or coprocessor 938. PCU 917 provides control information to a voltage regulator to cause the voltage regulator to generate the appropriate regulated voltage. PCU 917 also provides control information to control the operating voltage generated. In various embodiments, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other embodiments, power management operations to be performed by PCU 917 may be implemented externally to a processor, such as by way of a separate power management integrated circuit (PMIC) or another component external to the processor. In yet other embodiments, power management operations to be performed by PCU 917 may be implemented within BIOS or other system software.

Various I/O devices 914 may be coupled to first interconnect 916, along with an interconnect (bus) bridge 918 which couples first interconnect 916 to a second interconnect 920. In some embodiments, one or more additional processor(s) 915, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 916. In some embodiments, second interconnect 920 may be a low pin count (LPC) interconnect. Various devices may be coupled to second interconnect 920 including, for example, a keyboard and/or mouse 922, communication devices 927 and a storage unit circuitry 928. Storage unit circuitry 928 may be a disk drive or other mass storage device which may include instructions/code and data 930, in some embodiments. Further, an audio I/O 924 may be coupled to second interconnect 920. Note that other architectures than the point-to-point architecture described above are possible. For example, instead of the point-to-point architecture, a system such as multiprocessor system 900 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

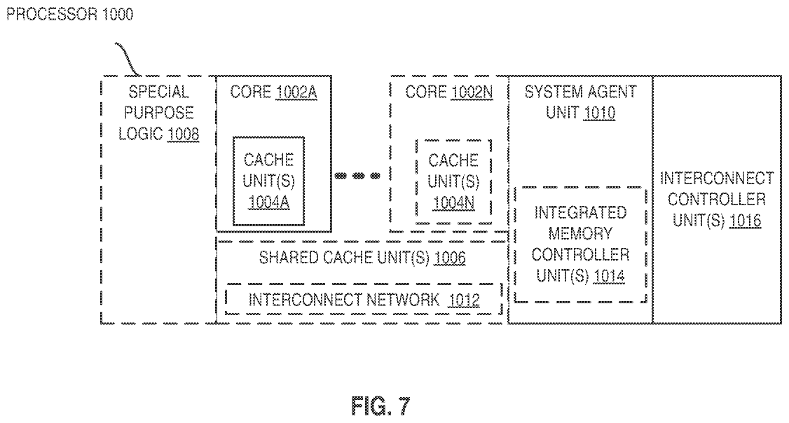

FIG. 7 illustrates a block diagram of embodiments of a processor 1000 that may have more than one core, may have an integrated memory controller, and may have integrated graphics. The solid lined boxes illustrate a processor 1000 with a single core 1002A, a system agent circuitry 1010, a set of one or more interconnect controller units circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010, and special purpose logic 1008, as well as a set of one or more interconnect controller units circuitry 1016. Note that the processor 1000 may be one of the processors 970 or 980, or coprocessor 938 or 915 of FIG. 6.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

A memory hierarchy includes one or more levels of cache unit(s) circuitry 1004(A)-(N) within the cores 1002(A)-(N), a set of one or more shared cache units circuitry 1006, and external memory (not shown) coupled to the set of integrated memory controller units circuitry 1014. The set of one or more shared cache units circuitry 1006 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 1012 interconnects the special purpose logic 1008 (e.g., integrated graphics logic), the set of shared cache units circuitry 1006, and the system agent unit circuitry 1010, alternative embodiments use any number of well-known techniques for interconnecting such units. In some embodiments, coherency is maintained between one or more of the shared cache units circuitry 1006 and cores 1002(A)-(N).

In some embodiments, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous or heterogeneous in terms of architecture instruction set; that is, two or more of the cores 1002(A)-(N) may be capable of executing the same instruction set, while other cores may be capable of executing only a subset of that instruction set or a different instruction set.

### Exemplary Core Architectures

### In-Order and Out-of-Order Core Block Diagram

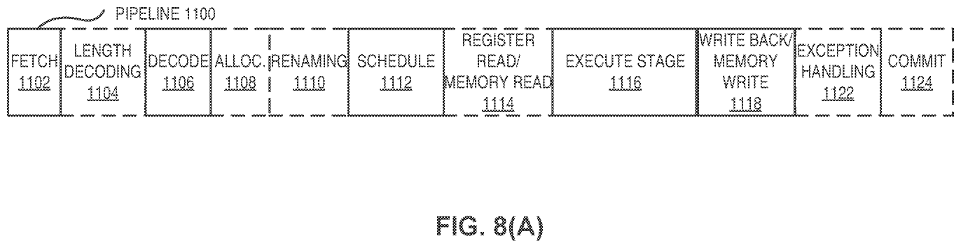

FIG. 8(A) is a block diagram illustrating both an exemplary in-order pipeline and an exemplary register renaming, out-of-order issue/execution pipeline according to embodiments of the invention. FIG. 8(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 1100 includes a fetch stage 1102, an optional length decode stage 1104, a decode stage 1106, an optional allocation stage 11011, an optional renaming stage 1110, a scheduling (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In one embodiment, the decode stage 1106 and the register read/memory read stage 1114 may be combined into one pipeline stage. In one embodiment, during the execute stage 1116, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 1100 as follows: 1) the instruction fetch circuitry 1138 performs the fetch and length decoding stages 1102 and 1104; 2) the decode unit circuitry 1140 performs the decode stage 1106; 3) the rename/allocator unit circuitry 1152 performs the allocation stage 1108 and renaming stage 1110; 4) the scheduler unit(s) circuitry 1156 performs the schedule stage 1112; 5) the physical register file(s) unit(s) circuitry 1158 and the memory unit circuitry 1170 perform the register read/memory read stage 1114; the execution cluster 1160 perform the execute stage 1116; 6) the memory unit circuitry 1170 and the physical register file(s) unit(s) circuitry 1158 perform the write back/memory write stage 1118; 7) various units (unit circuitry) may be involved in the exception handling stage 1122; and 8) the retirement unit circuitry 1154 and the physical register file(s) unit(s) circuitry 1158 perform the commit stage 1124.

FIG. 8(B) shows processor core 1190 including front-end unit circuitry 1130 coupled to an execution engine unit circuitry 1150, and both are coupled to a memory unit circuitry 1170. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit circuitry 1130 may include branch prediction unit circuitry 1132 coupled to an instruction cache unit circuitry 1134, which is coupled to an instruction translation lookaside buffer (TLB) 1136, which is coupled to instruction fetch unit circuitry 1138, which is coupled to decode unit circuitry 1140. In one embodiment, the instruction cache unit circuitry 1134 is included in the memory unit circuitry 1170 rather than the front-end unit circuitry 1130. The decode unit circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 1140 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM (not shown) or other medium that stores microcode for certain macroinstructions (e.g., in decode unit circuitry 1140 or otherwise within the front end unit circuitry 1130). In one embodiment, the decode unit circuitry 1140 includes a micro-operation (micro-op) or operation cache (not shown) to hold/cache decoded operations, micro-tags, or micro-operations generated during the decode or other stages of the processor pipeline 1100. The decode unit circuitry 1140 may be coupled to rename/allocator unit circuitry 1152 in the execution engine unit circuitry 1150.

The execution engine circuitry 1150 includes the rename/allocator unit circuitry 1152 coupled to a retirement unit circuitry 1154 and a set of one or more scheduler(s) circuitry 1156. The scheduler(s) circuitry 1156 represents any number of different schedulers, including reservations stations, central instruction window, etc. In some embodiments, the scheduler(s) circuitry 1156 can include arithmetic logic unit (ALU) scheduler/scheduling circuitry, ALU queues, arithmetic generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 1158 includes vector registers unit circuitry, write mask registers unit circuitry, and scalar register unit circuitry. These register units may provide architectural vector registers, vector mask registers, general-purpose registers, etc. The physical register file(s) unit(s) circuitry 1158 is overlapped by the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution units circuitry 1162 and a set of one or more memory access circuitry 1164. The execution units circuitry 1162 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 1156, physical register file(s) unit(s) circuitry 1158, and execution cluster(s) 1160 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 1164). It should also be understood that where separate pipelines are used, one or more of these pipelines may be out-of-order issue/execution and the rest in-order.

In some embodiments, the execution engine unit circuitry 1150 may perform load store unit (LSU) address/data pipelining to an Advanced Microcontroller Bus (AHB) interface (not shown), and address phase and writeback, data phase load, store, and branches.

The set of memory access circuitry 1164 is coupled to the memory unit circuitry 1170, which includes data TLB unit circuitry 1172 coupled to a data cache circuitry 1174 coupled to a level 2 (L2) cache circuitry 1176. In one exemplary embodiment, the memory access units circuitry 1164 may include a load unit circuitry, a store address unit circuit, and a store data unit circuitry, each of which is coupled to the data TLB circuitry 1172 in the memory unit circuitry 1170. The instruction cache unit circuitry 1134 is further coupled to a level 2 (L2) cache unit circuitry 1176 in the memory unit circuitry 1170. In one embodiment, the instruction cache unit circuitry 1134 and the data cache circuitry 1174 are combined into a single instruction and data cache (not shown) in L2 cache unit circuitry 1176, a level 3 (L3) cache unit circuitry (not shown), and/or main memory. The L2 cache unit circuitry 1176 is coupled to one or more other levels of cache and eventually to a main memory.

The core 1190 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 1190 includes logic to support a packed data instruction set extension (e.g., AVX1, AVX2), thereby allowing the operations used by many multimedia applications to be performed using packed data.

### Exemplary Execution Unit(s) Circuitry

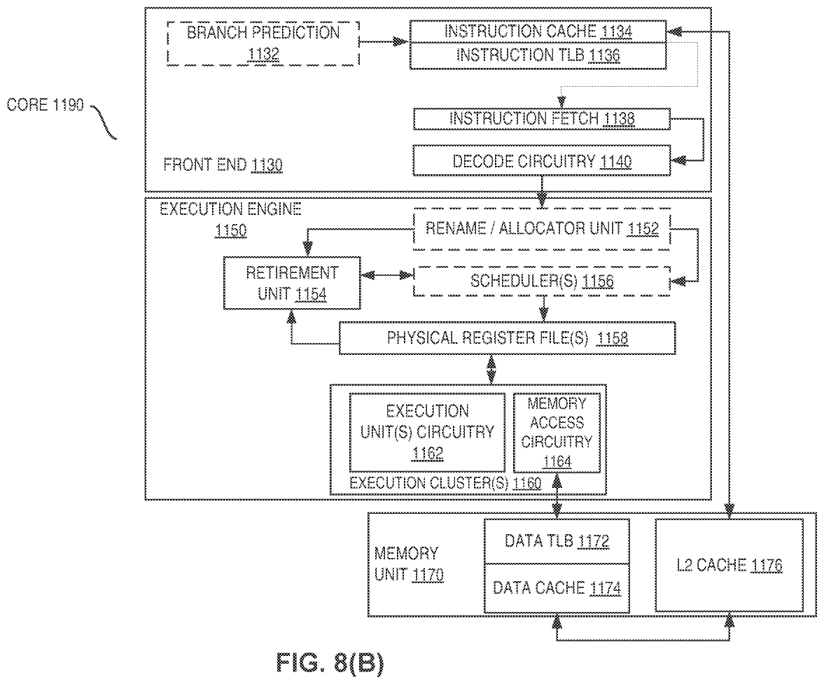

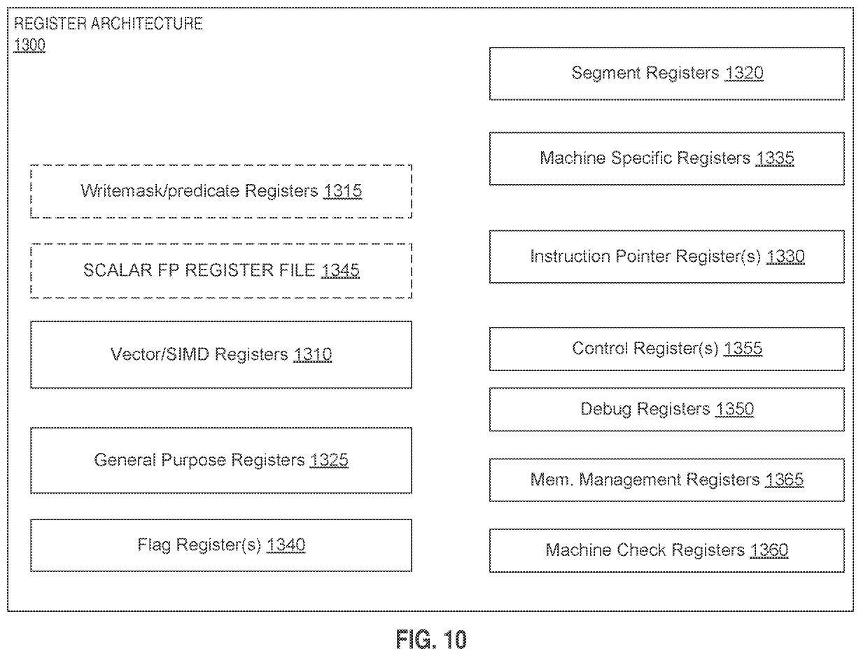

FIG. 9 illustrates embodiments of execution unit(s) circuitry, such as execution unit(s) circuitry 1162 of FIG. 11(B). As illustrated, execution unit(s) circuitry 1162 may include one or more ALU circuits 1201, vector/SIMD unit circuits 1203, load/store unit circuits 1205, and/or branch/jump unit circuits 1207. ALU circuits 1201 perform integer arithmetic and/or Boolean operations. Vector/SIMD unit circuits 1203 perform vector/SIMD operations on packed data (such as SIMD/vector registers). Load/store unit circuits 1205 execute load and store instructions to load data from memory into registers or store from registers to memory. Load/store unit circuits 1205 may also generate addresses. Branch/jump unit circuits 1207 cause a branch or jump to a memory address depending on the instruction. Floating-point unit (FPU) circuits 1209 perform floating-point arithmetic. The width of the execution unit(s) circuitry 1162 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

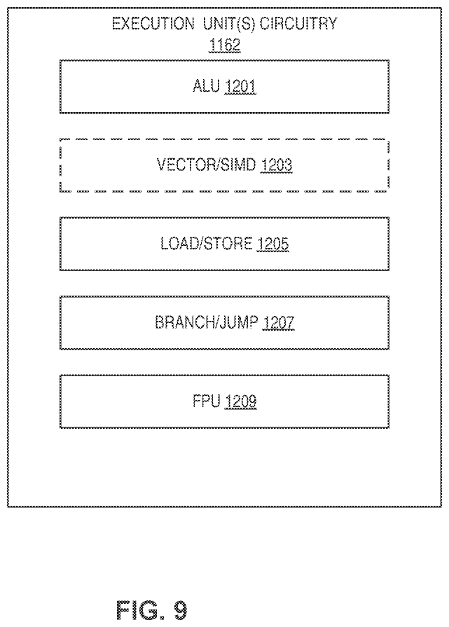

FIG. 10 is a block diagram of a register architecture 1300 according to some embodiments. As illustrated, there are vector/SIMD registers 1310 that vary from 128-bit to 1,024 bits width. In some embodiments, the vector/SIMD registers 1310 are physically 512-bits and, depending upon the mapping, only some of the lower bits are used. For example, in some embodiments, the vector/SIMD registers 1310 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 1300 includes write mask/predicate registers 1315. For example, in some embodiments, there are 8 write mask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 1315 corresponds to a data element position of the destination. In other embodiments, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 1300 includes scalar floating-point register 1345 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some embodiments, the one or more flag registers 1340 are called program status and control registers.

Segment registers 1320 contain segment points for use in accessing memory. In some embodiments, these registers are referenced by the names CS, DS, SS, ES, FS, and GS.

Machine specific registers (MSRs) 1335 control and report on processor performance. Most MSRs 1335 handle system-related functions and are not accessible to an application program. Machine check registers 1360 consist of control, status, and error reporting MSRs that are used to detect and report on hardware errors.

One or more instruction pointer register(s) 1330 store an instruction pointer value. Control register(s) 1355 (e.g., CR0-CR4) determine the operating mode of a processor (e.g., processor 970, 980, 938, 915, and/or 1000) and the characteristics of a currently executing task. Debug registers 1350 control and allow for the monitoring of a processor or core's debugging operations.

Memory management registers 1365 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

FIG. 11 illustrates embodiments of an instruction format. As illustrated, an instruction may include multiple components including, but not limited to, one or more fields for: one or more prefixes 1401, an opcode 1403, addressing field 1405 (e.g., register identifiers, memory addressing information, etc.), a displacement field 1407, and/or an immediate field 1409. Note that some instructions utilize some or all of the fields of the format whereas others may only use the field for the opcode 1403. In some embodiments, the order illustrated is the order in which these fields are to be encoded, however, it should be appreciated that in other embodiments these fields may be encoded in a different order, combined, etc.

The prefix(es) field(s) 1401, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode 1403 is used to at least partially define the operation to be performed upon a decoding of the instruction. In some embodiments, a primary opcode encoded in the opcode 1403 is 1, 2, or 3 bytes in length. In other embodiments, a primary opcode can be a different length. An additional 3-bit opcode field is sometimes encoded in another field.

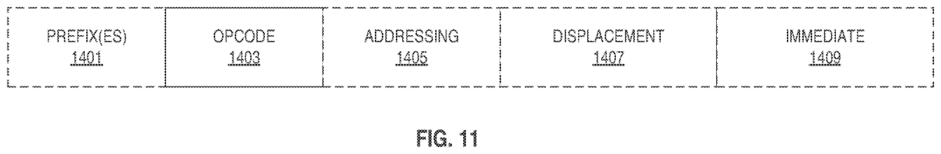

The addressing field 1405 is used to address one or more operands of the instruction, such as a location in memory or one or more registers. FIG. 12 illustrates embodiments of the addressing field 1405. In this illustration, an optional ModR/M byte 1202 and an optional Scale, Index, Base (SIB) byte 1204 are shown. The ModR/M byte 1202 and the SIB byte 1204 are used to encode up to two operands of an instruction, each of which is a direct register or effective memory address. Note that each of these fields are optional in that not all instructions include one or more of these fields. The MOD R/M byte 1202 includes a MOD field 1242, a register field 1244, and R/M field 1246.

The content of the MOD field 1242 distinguishes between memory access and non-memory access modes. In some embodiments, when the MOD field 1242 has a value of b11, a register-direct addressing mode is utilized, and otherwise register-indirect addressing is used.

The register field 1244 may encode either the destination register operand or a source register operand, or may encode an opcode extension and not be used to encode any instruction operand. The content of register index field 1244, directly or through address generation, specifies the locations of a source or destination operand (either in a register or in memory). In some embodiments, the register field 1244 is supplemented with an additional bit from a prefix (e.g., prefix 1101) to allow for greater addressing.

The R/M field 1246 may be used to encode an instruction operand that references a memory address, or may be used to encode either the destination register operand or a source register operand. Note the R/M field 1246 may be combined with the MOD field 1242 to dictate an addressing mode in some embodiments.

The SIB byte 1204 includes a scale field 1252, an index field 1254, and a base field 1256 to be used in the generation of an address. The scale field 1252 indicates scaling factor. The index field 1254 specifies an index register to use. In some embodiments, the index field 1254 is supplemented with an additional bit from a prefix (e.g., prefix 1101) to allow for greater addressing. The base field 1256 specifies a base register to use. In some embodiments, the base field 1256 is supplemented with an additional bit from a prefix (e.g., prefix 1101) to allow for greater addressing. In practice, the content of the scale field 1252 allows for the scaling of the content of the index field 1254 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 1407 provides this value. Additionally, in some embodiments, a displacement factor usage is encoded in the MOD field of the addressing field 1405 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 1407.

In some embodiments, an immediate field 1409 specifies an immediate for the instruction. An immediate may be encoded as a 1-byte value, a 2-byte value, a 4-byte value, etc.

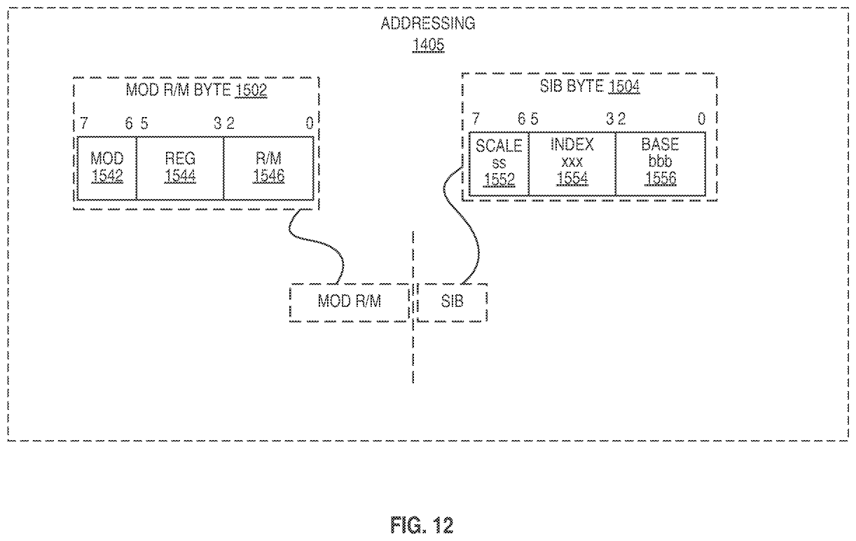

FIG. 13 illustrates embodiments of a first prefix 1401(A). In some embodiments, the first prefix 1401(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1401(A) may specify up to three registers using 3-bit fields depending on the format: 1) using the reg field 1544 and the R/M field 1546 of the Mod R/M byte 1502; 2) using the Mod R/M byte 1502 with the SIB byte 1504 including using the reg field 1544 and the base field 1556 and index field 1554; or 3) using the register field of an opcode.

In the first prefix 1401(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1544 and MOD R/M R/M field 1546 alone can each only address 8 registers.

In the first prefix 1401(A), bit position 2 (R) may an extension of the MOD R/M reg field 1544 and may be used to modify the ModR/M reg field 1544 when that field encodes a general purpose register, a 64-bit packed data register (e.g., a SSE register), or a control or debug register. R is ignored when Mod R/M byte 1502 specifies other registers or defines an extended opcode.

Bit position 1 (X) X bit may modify the SIB byte index field 1554.

Bit position B (B) B may modify the base in the Mod R/M R/M field 1546 or the SIB byte base field 1556; or it may modify the opcode register field used for accessing general purpose registers (e.g., general purpose registers 1025).

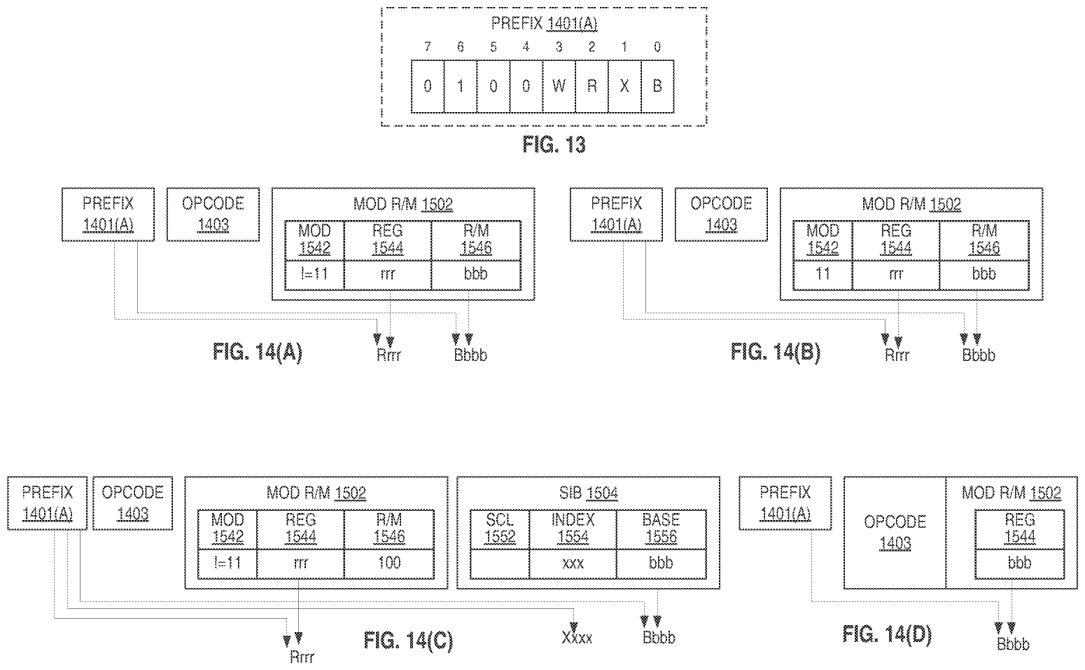

FIGS. 14(A)-(D) illustrate embodiments of how the R, X, and B fields of the first prefix 1401(A) are used. FIG. 14(A) illustrates R and B from the first prefix 1401(A) being used to extend the reg field 1544 and R/M field 1546 of the MOD R/M byte 1502 when the SIB byte 1504 is not used for memory addressing. FIG. 14(B) illustrates R and B from the first prefix 1401(A) being used to extend the reg field 1544 and R/M field 1546 of the MOD R/M byte 1502 when the SIB byte 1504 is not used (register-register addressing). FIG. 14(C) illustrates R, X, and B from the first prefix 1401(A) being used to extend the reg field 1544 of the MOD R/M byte 1502 and the index field 1554 and base field 1556 when the SIB byte 1504 being used for memory addressing. FIG. 14(D) illustrates B from the first prefix 1401(A) being used to extend the reg field 1544 of the MOD R/M byte 1502 when a register is encoded in the opcode 1403.

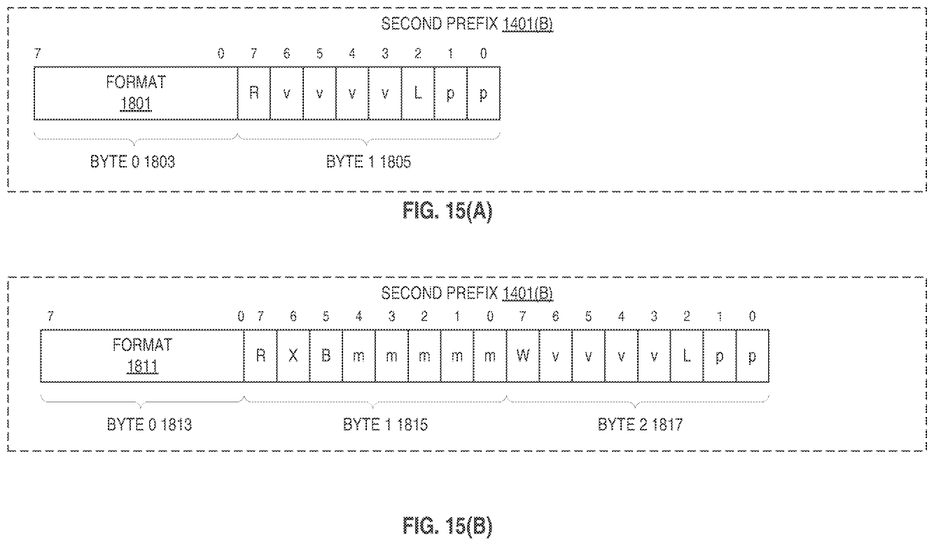

FIGS. 15(A)-(B) illustrate embodiments of a second prefix 1401(B). In some embodiments, the second prefix 1401(B) is an embodiment of a VEX prefix. The second prefix 1401(B) encoding allows instructions to have more than two operands, and allows SIMD vector registers (e.g., vector/SIMD registers) to be longer than 64-bits (e.g., 128-bit and 256-bit). The use of the second prefix 1401(B) provides for three-operand (or more) syntax. For example, previous two-operand instructions performed operations such as A=A+B, which overwrites a source operand. The use of the second prefix 1401(B) enables operands to perform nondestructive operations such as A=B+C.

In some embodiments, the second prefix 1401(B) comes in two forms-a two-byte form and a three-byte form. The two-byte second prefix 1401(B) is used mainly for 128-bit, scalar, and some 256-bit instructions; while the three-byte second prefix 1401(B) provides a compact replacement of the first prefix 1401(A) and 3-byte opcode instructions.

FIG. 15(A) illustrates embodiments of a two-byte form of the second prefix 1401(B). In one example, a format field 1801 (byte 0 1803) contains the value C5H. In one example, byte 1 1805 includes a “R” value in bit [7]. This value is the complement of the same value of the first prefix 1401(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1546 to encode the instruction operand that references a memory address or encode either the destination register operand or a source register operand.

Instructions that use this prefix may use the Mod R/M reg field 1544 to encode either the destination register operand or a source register operand, be treated as an opcode extension and not used to encode any instruction operand.

For instruction syntax that support four operands, vvvv, the Mod R/M R/M field 1546 and the Mod R/M reg field 1544 encode three of the four operands. Bits [7:4] of the immediate 1109 are then used to encode the third source register operand.

FIG. 15(B) illustrates embodiments of a three-byte form of the second prefix 1401(B). in one example, a format field 1811 (byte 0 1513) contains the value C4H. Byte 1 1815 includes in bits [7:5] “R,” “X,” and “B” which are the complements of the same values of the first prefix 1401(A). Bits [4:0] of byte 1 1815 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit [7] of byte 2 1817 is used similar to W of the first prefix 1401(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1546 to encode the instruction operand that references a memory address or encode either the destination register operand or a source register operand.

Instructions that use this prefix may use the Mod R/M reg field 1544 to encode either the destination register operand or a source register operand, be treated as an opcode extension and not used to encode any instruction operand.

For instruction syntax that support four operands, vvvv, the Mod R/M R/M field 1546, and the Mod R/M reg field 1544 encode three of the four operands. Bits [7:4] of the immediate 1109 are then used to encode the third source register operand.

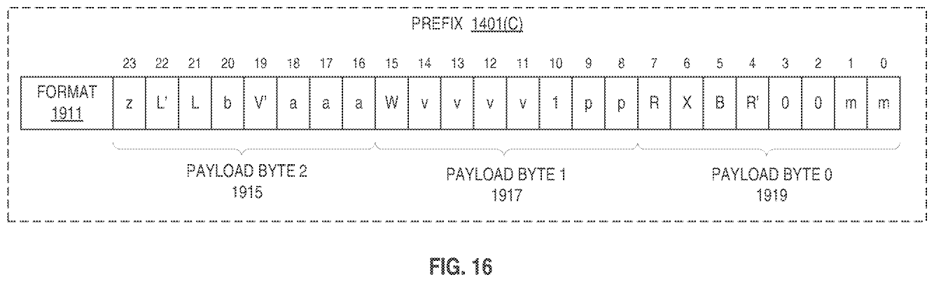

FIG. 16 illustrates embodiments of a third prefix 1401(C). In some embodiments, the first prefix 1401(A) is an embodiment of an EVEX prefix. The third prefix 1401(C) is a four-byte prefix.

The third prefix 1401(C) can encode 32 vector registers (e.g., 128-bit, 256-bit, and 512-bit registers) in 64-bit mode. In some embodiments, instructions that utilize a write mask/opmask (see discussion of registers in a previous figure, such as FIG. 15) or predication utilize this prefix. Opmask register allow for conditional processing or selection control. Opmask instructions, whose source/destination operands are opmask registers and treat the content of an opmask register as a single value, are encoded using the second prefix 1401(B).

The third prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1401(C) is a format field 1911 that has a value, in one example, of 62H. Subsequent bytes are referred to as payload bytes 1915-119 and collectively form a 24-bit value of P[23:0] providing specific capability in the form of one or more fields (detailed herein).

In some embodiments, P[1:0] of payload byte 1619 are identical to the low two mmmmm bits. P[3:2] are reserved in some embodiments. Bit P[4] (R′) allows access to the high 16 vector register set when combined with P[7] and the ModR/M reg field 1544. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1544 and ModR/M R/M field 1546. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1401(A) and second prefix 1401(B) and may serve as an opcode extension bit or operand size promotion.

P[18:16] specify the index of a register in the opmask (write mask) registers (e.g., write mask/predicate registers 1315). In one embodiment of the invention, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P [22:21]). P[23] indicates support for merging-write masking (e.g., when set to 0) or support for zeroing and merging-write masking (e.g., when set to 1).

Exemplary embodiments of encoding of registers in instructions using the third prefix 1401(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

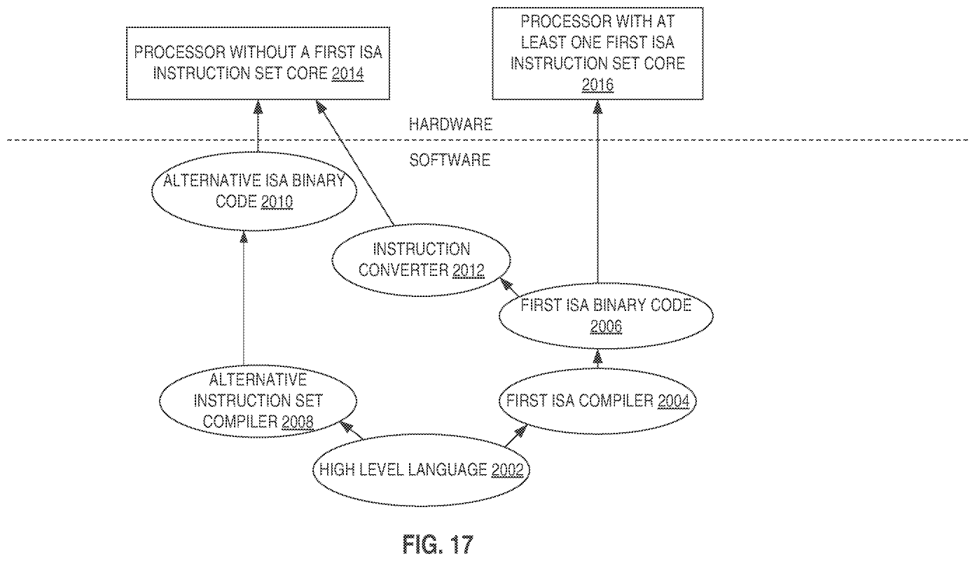

FIG. 17 illustrates a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 17 shows a program in a high-level language 2002 may be compiled using a first ISA compiler 2004 to generate first ISA binary code 2006 that may be natively executed by a processor with at least one first instruction set core 2016. The processor with at least one first ISA instruction set core 2016 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 2004 represents a compiler that is operable to generate first ISA binary code 2006 (e.g., object code) that can, with or without additional linkage processing, be executed on the processor with at least one first ISA instruction set core 2016. Similarly, FIG. 17 shows the program in the high-level language 2002 may be compiled using an alternative instruction set compiler 2008 to generate alternative instruction set binary code 2010 that may be natively executed by a processor without a first ISA instruction set core 2014. The instruction converter 2012 is used to convert the first ISA binary code 2006 into code that may be natively executed by the processor without a first ISA instruction set core 2014. This converted code is not likely to be the same as the alternative instruction set binary code 2010 because an instruction converter capable of this is difficult to make; however, the converted code will accomplish the general operation and be made up of instructions from the alternative instruction set. Thus, the instruction converter 2012 represents software, firmware, hardware, or a combination thereof that, through emulation, simulation or any other process, allows a processor or other electronic device that does not have a first ISA instruction set processor or core to execute the first ISA binary code 2006.

References to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Moreover, in the various embodiments described above, unless specifically noted otherwise, disjunctive language such as the phrase “at least one of A, B, or C” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

Exemplary embodiments include, but are not limited to, the following examples. Example 1 is a first physical processor including decoder circuitry to decode a single instruction, the single instruction to include a field for an opcode; and execution processing resources to execute the decoded single instruction according to the opcode to cause a host to guest notification from a virtual device running in a host machine on the first physical processor to a virtual device driver running on a virtual processor in a guest machine on a second physical processor.

In Example 2, the subject matter of Example 1 can optionally include wherein the execution processing resources to send a posted interrupt (PI) inter-processor posted interrupt (IPI) as the host to guest notification to the second physical processor running the virtual device driver on the virtual processor in the guest machine.

In Example 3, the subject matter of Example 1 can optionally include wherein the virtual device is a host user space thread on the first physical processor.

In Example 4, the subject matter of Example 1 can optionally include wherein the single instruction comprises a send user inter-processor interrupt instruction (SENDUIPI) and the virtual device running in the host machine executes the SENDUIPI instruction on the first physical processor.

In Example 5, the subject matter of Example 4 can optionally include wherein the execution processing resources to get an entry from a user interrupt target table (UITT) indexed by an operand of the SENDUIPI instruction and configure a posted interrupt descriptor (PID) associated with the UITT entry.

In Example 6, the subject matter of Example 5 can optionally include wherein a PID type field of the indexed UITT entry indicates an address in the indexed UITT entry pointing to a memory location in the host machine's posted interrupt descriptor (PID) memory in PID format.

Example 7 is a method including decoding a single instruction, the single instruction to include a field for an opcode; and processing the decoded single instruction according to the opcode to cause a host to guest notification from a virtual device running in a host machine on a first physical processor to a virtual device driver running on a virtual processor in a guest machine on a second physical processor.

In Example 8, the subject matter of Example 7 can optionally include sending a posted interrupt (PI) inter-processor posted interrupt (IPI) as the host to guest notification to the second physical processor running the virtual device driver on the virtual processor in the guest machine.

In Example 9, the subject matter of Example 7 can optionally include the second physical processor notifying the virtual device driver in response to receiving the PI IPI.

In Example 10, the subject matter of Example 7 can optionally include wherein the virtual device is a host user space thread on the first physical processor.

In Example 11, the subject matter of Example 7 can optionally include wherein the single instruction comprises a send user inter-processor interrupt instruction (SENDUIPI) and the virtual device running in the host machine executes the SENDUIPI instruction on the first physical processor.

In Example 12, the subject matter of Example 11 can optionally include getting an entry from a user interrupt target table (UITT) indexed by an operand of the SENDUIPI instruction and configuring a posted interrupt descriptor (PID) associated with the UITT entry.

In Example 13, the subject matter of Example 12 can optionally include wherein a PID type field of the indexed UITT entry indicates an address in the indexed UITT entry pointing to a memory location in the host machine's posted interrupt descriptor (PID) memory in PID format.

Example 14 is a system including a first physical processor core including decoder circuitry to decode a single instruction, the single instruction to include a field for an opcode; and execution processing resources to execute the decoded single instruction according to the opcode to cause a host to guest notification from a virtual device running in a host machine on the first physical processor core to a virtual device driver running on a virtual processor in a guest machine on a second physical processor core; and a memory coupled to the first physical processor core to store the single instruction.

In Example 15, the subject matter of Example 14 can optionally include wherein the execution processing resources to send a posted interrupt (PI) inter-processor posted interrupt (IPI) as the host to guest notification to the second physical processor core running the virtual device driver on the virtual processor in the guest machine.

In Example 16, the subject matter of Example 14 can optionally include wherein the virtual device is a host user space thread on the first physical processor core.

In Example 17, the subject matter of Example 14 can optionally include wherein the single instruction comprises a send user inter-processor interrupt instruction (SENDUIPI) and the virtual device running in the host machine executes the SENDUIPI instruction on the first physical processor core.

In Example 18, the subject matter of Example 14 can optionally include wherein the execution processing resources to get an entry from a user interrupt target table (UITT) indexed by an operand of the SENDUIPI instruction and configure a posted interrupt descriptor (PID) associated with the UITT entry.

In Example 19, the subject matter of Example 18 can optionally include wherein a PID type field of the indexed UITT entry indicates an address in the indexed UITT entry pointing to a memory location in the host machine's posted interrupt descriptor (PID) memory in PID format.

Example 20 provides an apparatus comprising means for performing the method of any one of Examples 7-13.

Example 21 comprises the subject matter of Example 20 and the means for performing the method comprises a processor and at least one memory.

Example 22 comprises the subject matter of Example 20 and the at least one memory comprises machine readable instructions that when executed, cause the apparatus to perform the method of any one of Examples 7-13.

Example 23 comprises the subject matter of any one of Examples 1-8 and the first physical processor is a system-on-a-chip.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A first physical processor comprising:
decoder circuitry to decode a single instruction, the single instruction to include a field for an opcode; and
execution processing resources to execute the decoded single instruction according to the opcode to cause a host to guest (H2G) notification from a virtual device running in a host machine on the first physical processor to a virtual device driver running on a virtual processor in a guest machine on a second physical processor.

2. The first physical processor of claim 1, wherein the execution processing resources to send a posted interrupt (PI) inter-processor posted interrupt (IPI) as the H2G notification to the second physical processor running the virtual device driver on the virtual processor in the guest machine.

3. The first physical processor of claim 1, wherein the virtual device is a host user space thread on the first physical processor.

4. The first physical processor of claim 1, wherein the single instruction comprises a send user inter-processor interrupt instruction and the virtual device running in the host machine executes the SENDUIPI instruction on the first physical processor.

5. The first physical processor of claim 4, wherein the execution processing resources to get an entry from a user interrupt target table (UITT) indexed by an operand of the send user inter-processor interrupt instruction and configure a posted interrupt descriptor (PID) associated with the UITT entry.

6. The first physical processor of claim 5, wherein a PID type field of the indexed UITT entry indicates an address in the indexed UITT entry pointing to a memory location in the host machine's posted interrupt descriptor (PID) memory in PID format.

7. A method comprising:
decoding a single instruction, the single instruction to include a field for an opcode; and
processing the decoded single instruction according to the opcode to cause a host to guest (H2G) notification from a virtual device running in a host machine on a first physical processor to a virtual device driver running on a virtual processor in a guest machine on a second physical processor.

8. The method of claim 7, comprising sending a posted interrupt (PI) inter-processor posted interrupt (IPI) as the H2G notification to the second physical processor running the virtual device driver on the virtual processor in the guest machine.

9. The method of claim 8, comprising the second physical processor notifying the virtual device driver in response to receiving the PI IPI.

10. The method of claim 7, wherein the virtual device is a host user space thread on the first physical processor.

11. The method of claim 7, wherein the single instruction comprises a send user inter-processor interrupt instruction and the virtual device running in the host machine executes the send user inter-processor interrupt instruction on the first physical processor.

12. The method of claim 11, comprising getting an entry from a user interrupt target table (UITT) indexed by an operand of the send user inter-processor interrupt instruction and configuring a posted interrupt descriptor (PID) associated with the UITT entry.

13. The method of claim 12, wherein a PID type field of the indexed UITT entry indicates an address in the indexed UITT entry pointing to a memory location in the host machine's posted interrupt descriptor (PID) memory in PID format.

14. A system comprising:
a first physical processor core including:
decoder circuitry to decode a single instruction, the single instruction to include a field for an opcode; and
execution processing resources to execute the decoded single instruction according to the opcode to cause a host to guest (H2G) notification from a virtual device running in a host machine on the first physical processor core to a virtual device driver running on a virtual processor in a guest machine on a second physical processor core; and
a memory coupled to the first physical processor core to store the single instruction.

15. The system of claim 14, wherein the execution processing resources to send a posted interrupt (PI) inter-processor posted interrupt (IPI) as the H2G notification to the second physical processor core running the virtual device driver on the virtual processor in the guest machine.

16. The system of claim 14, wherein the virtual device is a host user space thread on the first physical processor core.

17. The system of claim 14, wherein the single instruction comprises a send user inter-processor interrupt instruction and the virtual device running in the host machine executes the send user inter-processor interrupt instruction on the first physical processor core.

18. The system of claim 17, wherein the execution processing resources to get an entry from a user interrupt target table (UITT) indexed by an operand of the send user inter-processor interrupt instruction and configure a posted interrupt descriptor (PID) associated with the UITT entry.

19. The system of claim 18, wherein a PID type field of the indexed UITT entry indicates an address in the indexed UITT entry pointing to a memory location in the host machine's posted interrupt descriptor (PID) memory in PID format.
